(19) United States
(12) Patent Application Publication
(10) Pub. No.: US 2016/0280060 A1
(43) Pub. Date: Sep. 29, 2016

(54) INTEGRATED NVH DECOUPLER AND FRONT IMPACT BRACE

(71) Applicant: FORD GLOBAL TECHNOLOGIES, LLC, Dearborn, MI (US)

(72) Inventors: Danial Sullivan, Dearborn, MI (US); Rajarathinam Jayachandran, Canton, MI (US); Nikhil Illindala, Farmington Hills, MI (US); Samer Wadi, Windsor (CA)

(21) Appl. No.: 14/666,446

(22) Filed: Mar. 24, 2015

(51) Int. Cl. B60K 11/08; B62D 25/08; B60K 11/04

(52) U.S. Cl. CPC B60K 11/08; B60K 11/04; B62D 25/084

(57) ABSTRACT

An integrated noise, vibration, and harshness (NVH) decoupler and front impact brace for a vehicle includes one or more brackets configured for attaching at a first end to a front grille support member and at an opposed end to a radiator support member, and an air flow deflector strip associated with the one or more brackets. The air flow deflector strip is carried by the brackets, and is configured to substantially prevent a flow of air through a gap defined between the front grille support member and a lower air deflector of the vehicle. The one or more brackets each include at least one curved retainer for holding the air flow deflector strip. A system for reducing noise, vibration, and harshness (NVH) in a vehicle including the integrated NVH decoupler and front impact brace is described.

### TECHNICAL FIELD

This disclosure relates generally to structures for reducing noise, vibration, and harshness (NVH) in a motor vehicle. More particularly, the disclosure relates to an integrated NVH decoupler and brace which advantageously not only reduces NVH during vehicle operation, but also reduces damage to the cooling system in the event of a frontal impact to the vehicle.

### BACKGROUND

The typical motor vehicle includes a powertrain and a cooling system which provides a desirable heat-exchanging function to cool various engine components. The vehicle also includes a body structure of varying configurations, typically including an engine compartment, a compartment for vehicle occupants and other elements. Still more, various structures are provided for supporting the powertrain, cooling system components, etc.

The motor vehicle cooling system typically includes various components configured to circulate air and/or a cooling fluid through the vehicle engine to dissipate excess heat. The vehicle cooling system will usually include at least a radiator supported by one or more radiator support members providing a platform for the radiator, and one or more coolant hoses that conduct a coolant fluid to and from the radiator. In addition, one or more radiator-associated cooling fans (which may be engine-driven and/or electrically powered) are provided, configured to force air over cooling fins in the radiator to remove heat from the cooling fluid flowing therethrough. It is likewise known to utilize vehicle motion-induced airflow through grille openings in the vehicle front grille assembly to contribute to the cooling system. Advantageously, particularly during vehicle operation this provides a convenient source of supplemental cooling to vehicle components such as the engine, radiator, etc.

However, when the vehicle engine and cooling system are not operating at capacity and so require less supplemental cooling, such unimpeded cooling airflow may be unnecessary. Moreover, such airflow is known to increase aerodynamic drag of the vehicle, concomitantly lessening fuel economy. Therefore, it is also known to provide grille shutter systems as part of the vehicle cooling system, the shutter systems including pivoting vanes which may be opened or closed to selectively increase or decrease the airflow reaching the engine compartment from the front grille openings. When less airflow is required, for example when the motor and/or radiator are not operating at a high capacity and so require less cooling, the vanes may be partially or fully closed to lessen airflow into the engine compartment. This reduces aerodynamic drag during vehicle operation, improving aerodynamic properties of the vehicle and so improving fuel economy.

Each of the above-discussed vehicle components (engine, cooling fans, etc.) can generate significant vehicle noise, vibration, and harshness (NVH) during operation, lessening the quality of the vehicle user's experience. For that reason, in this art field significant engineering effort has been devoted to reducing NVH during operation of a motor vehicle, to lessen noise and vibration and so improve the vehicle user's experience. In particular, significant engineering effort has been devoted to managing air flow during operation of a motor vehicle.

In prior art designs, a lower air deflector is provided extending from the cooling system frontwardly towards the front grille openings, designed to direct air from the grille opening/grille shutter system into the cooling system, and also to prevent extraneous (i.e., other than through the front grille openings) air from recirculating into the engine compartment and cooling system. Such extraneous air can interfere with efficient air flow to the cooling system from the front grille openings, and also contributes to undesired noise. In conventional systems, the lower air deflector extends from the underside of the cooling system frontwardly to the front grille/grille shutter system assembly. However, this arrangement results in the lower air deflector rigidly coupling the cooling system (typically at the lower radiator support) and the grille shutter system, causing vibrations from the powertrain to be transmitted to other elements of the vehicle body, e.g., the steering wheel, driver/passenger seat track, etc. This arrangement also introduces difficulties in loading the vehicle engine into the body without causing contact of the lower air deflector into the vehicle front fascia, preventing a desirable “no-build” assembly process for these vehicle components.

Other prior art designs take the approach of providing a flexible lower air deflector, to control air flow to the cooling system as described above but also to reduce transmission of vibrations from the powertrain as was encountered with the rigid lower air deflector designs. However, it was found that such flexible lower air deflectors, while controlling air flow as intended, allowed the front grille/grille shutter assembly to translate rearwardly in the event of a frontal impact to the vehicle. Even in a low speed frontal impact, it was found that the vehicle grille and grille shutter system translated rearwardly a sufficient distance to cause collateral damage to other components packaged in the engine compartment, such as the radiator and other elements of the cooling system. Because of this, even relatively minor low speed frontal impacts to the vehicle often exponentially increase repair costs and insurance liability. For this reason, significant engineering expertise and effort have also been devoted to methods, devices, and structures for reducing collateral damage to elements of the vehicle in the event of, e.g., a frontal impact to the vehicle.

### SUMMARY

To address the above and other problems and in accordance with the purposes and benefits described herein, an integrated NVH decoupler and front impact brace are provided. The described integrated NVH decoupler and brace have surprisingly been found to not only reduce NVH due to transmission of vibration/noise between the vehicle cooling pack and vehicle body, but also to reduce damage to other components of the vehicle engine compartment and cooling pack such as the radiator and associated housing in the event of a frontal impact to the vehicle. As will be described, in combination the integrated NVH decoupler and front impact brace and an existing vehicle lower air deflector form a continuous seal. In turn, the described integrated NVH decoupler and front impact brace allowed shortening of the vehicle lower air deflector compared to conventional designs, resolving the engine no-build assembly issue described above and allowing maintaining a desired air flow pattern.

In embodiments, the integrated NVH decoupler and front impact brace include one or more brackets configured for attaching at a first end to a front grille support member and at an opposed end to a radiator support member. An air flow deflector strip is associated with the one or more brackets, configured to substantially prevent a flow of air through a gap defined between the front grille support member and a lower air deflector of the vehicle. In embodiments, the air flow deflector strip is carried by the one or more brackets whereby the brackets attach directly to elements of the vehicle but the air flow deflector strip is otherwise decoupled from the vehicle. The front grille support member may be a grille shutter system housing and the radiator support member may be a lower radiator support member.

In embodiments, the one or more brackets each include at least one snap-fit fastener for attaching to at least one cooperating aperture defined in the lower radiator support member. The one or more brackets may further each include at least one reinforcing rib structure to provide rigidity to the bracket without unduly increasing the weight of each bracket. The one or more brackets may further include at least one curved retainer for holding the air flow deflector strip in place.

In another aspect, an assembly for reducing noise, vibration, and harshness (NVH) in a vehicle is provided, including a vehicle front grille support member, a vehicle radiator support member, and an integrated NVH decoupler and front impact brace as described above.

In the following description, there are shown and described several embodiments of the described integrated NVH decoupler and front brace. As it should be realized, the device is capable of other, different embodiments and its several details are capable of modification in various, obvious aspects all without departing from the integrated NVH decoupler and front brace as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the integrated NVH decoupler and front brace and together with the description serve to explain certain principles thereof. In the drawing figures:

FIG. 1 shows a top perspective view of an embodiment of an integrated NVH decoupler and front brace according to the present disclosure;

FIG. 2 shows a bottom perspective view of the integrated NVH decoupler and front brace of FIG. 1;

FIG. 3 depicts the integrated NVH decoupler and front brace of FIG. 1 bridging the gap between a vehicle grille housing and the vehicle radiator lower support;

FIG. 4 shows a bottom perspective view of an alternative embodiment of an integrated NVH decoupler and front brace according to the present disclosure;

FIG. 5 shows a top perspective view of the integrated NVH decoupler and front brace of FIG. 4; and

FIG. 6 depicts the integrated NVH decoupler and front brace of FIG. 4 bridging the gap between the vehicle grille housing and the vehicle radiator lower support.

Reference will now be made in detail to the present preferred embodiments of the integrated NVH decoupler and front brace of the disclosure, examples of which are illustrated in the accompanying drawing figures.

### DETAILED DESCRIPTION

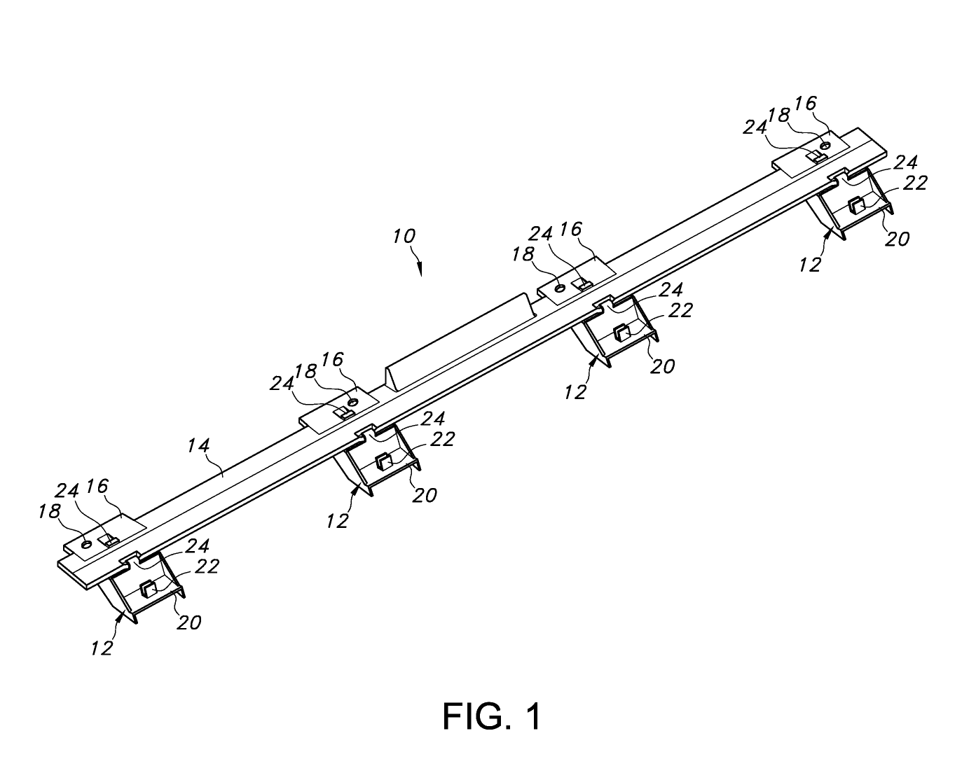

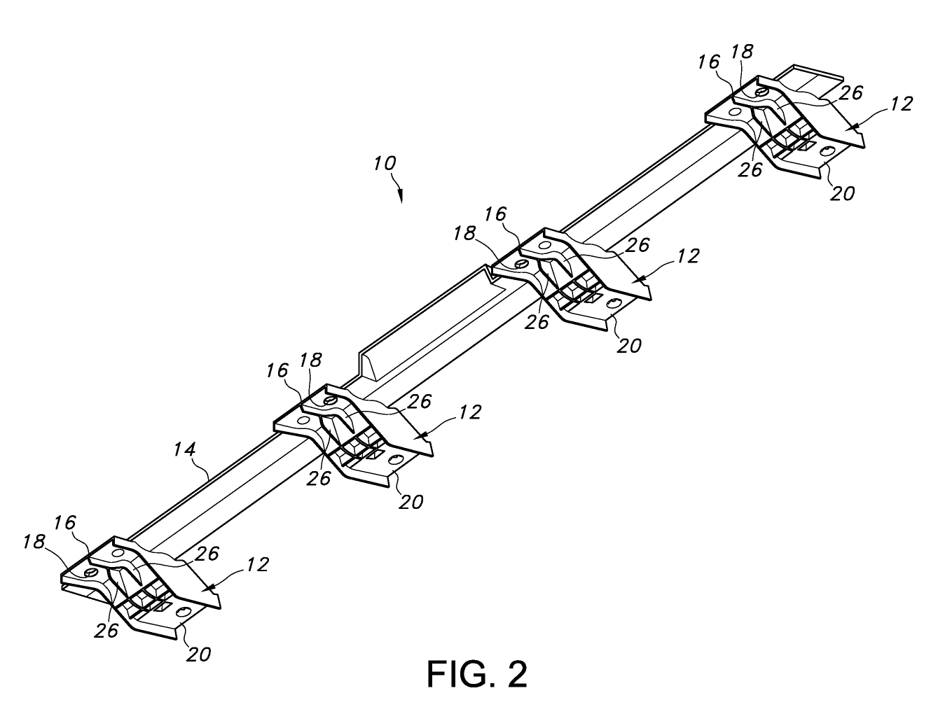

With reference to FIGS. 1 and 2, an integrated NVH decoupler and front impact brace 10 are provided. In one embodiment the integrated NVH decoupler and front impact brace 10 includes one or more brackets 12 and an air flow deflector strip 14. Each bracket 12 includes a first portion 16 adapted to be attached to a component of a grille assembly and/or grille shutter system (not shown in this view), for example by one or more apertures 18 for receiving fasteners (not shown in this view) such as self-threading bolts or screws. Each bracket 12 may also include a second portion 20 adapted for attaching to a component of a cooling system, for example to a lower radiator support (not shown in this view). In the depicted embodiment, a snap-fit fastener 22 is included in second portion 20, which as will be described below provides ease of assembly to a vehicle.

Each bracket 12 includes also at least one angular retainer 24 for holding the air flow deflector strip 14 in place. In turn (see FIG. 2), each bracket 12 may also include at least one structural rib member 26, providing rigidity to the bracket 12 structure.

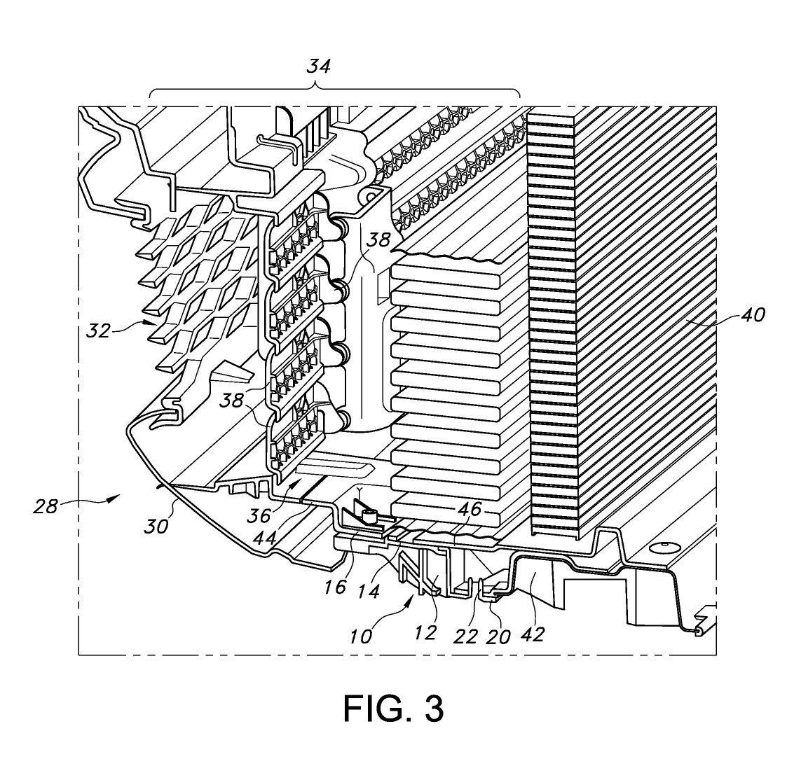

Advantages of an integrated NVH decoupler and front impact brace 10 according to the present disclosure will now be described. With reference to FIG. 3, a vehicle 28 is provided with a cooling system including a front fascia 30 defining one or more grille openings 32. The cooling system further includes a front grille assembly 34 provided with, in the depicted embodiment, an active grille shutter system 36 having a plurality of rotatable vanes 38. A radiator 40 is supported on a lower radiator support member 42. The grille shutter system 36 is supported by housing 44. The purpose and function of these elements of the vehicle 28 is well known in the art, and does not require detailed discussion herein.

For airflow management, a lower air deflector 46 is provided to control the flow of air through grille openings 32 and grille shutter system 36. However, as can be seen in the drawing figure, a gap exists between a trailing edge of the grille shutter system housing 44 and a leading edge of the lower air deflector 46. If unblocked, this gap would allow leakage of airflow passing through the vehicle engine compartment and/or introduction of underbody airflow into the engine compartment, each of which would contribute not only to lessened aerodynamic drag but also to NVH. To solve this, the integrated NVH decoupler and front impact brace 10 is attached as shown to substantially seal that gap. That is, when assembled the integrated NVH decoupler and front impact brace 10 and lower air deflector 46 provide a continuous seal to the gap between the trailing edge of the grille shutter system housing 44 and the leading edge of the lower air deflector 46.

As shown, the first portion 16 of bracket 12 is attached to a portion of the grille shutter system housing 44, in the depicted embodiment using a self-threading fastener for convenience which mates with a cooperating aperture in the housing 44. The second portion 20 of bracket 12 is attached to the radiator support 42, using the snap-fit fastener 22 which mates with a cooperating aperture in the housing 44. As will be appreciated, use of self-threading fasteners and snap-fit fastener 22 provide convenience to the manufacturer during vehicle assembly. However, it will also be appreciated that the depicted fasteners are not intended to be limiting, and that any suitable fasteners are contemplated for attaching the bracket 12 as described. Once the bracket 12 is attached as described above, as can be seen the air flow deflector strip 14 of the integrated NVH decoupler and front impact brace 10 bridges and substantially seals the gap between the trailing edge of the grille shutter system housing 44 and the leading edge of the lower air deflector 46.

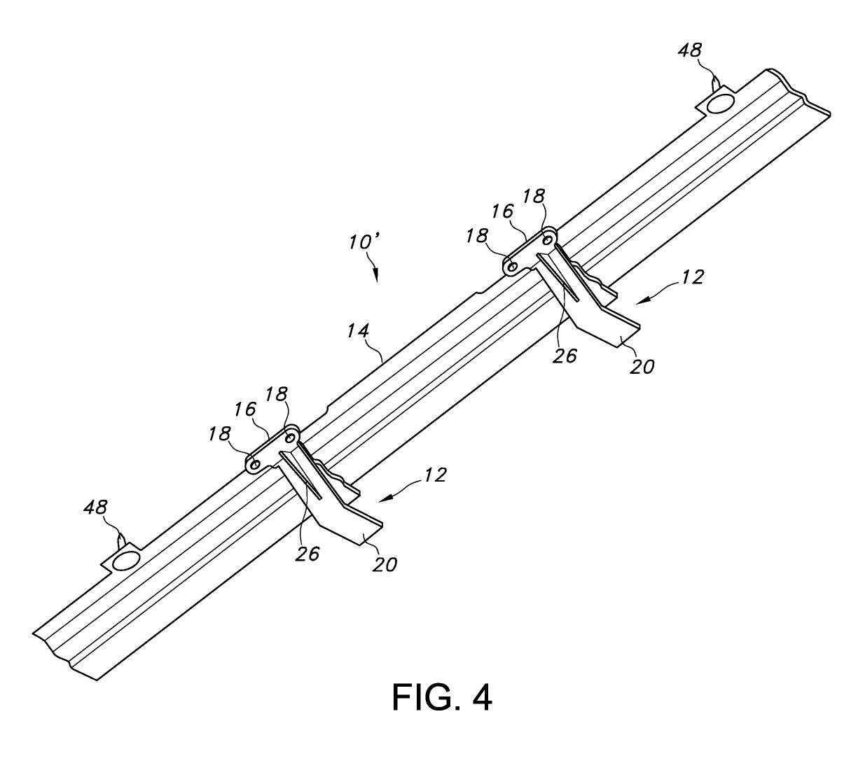

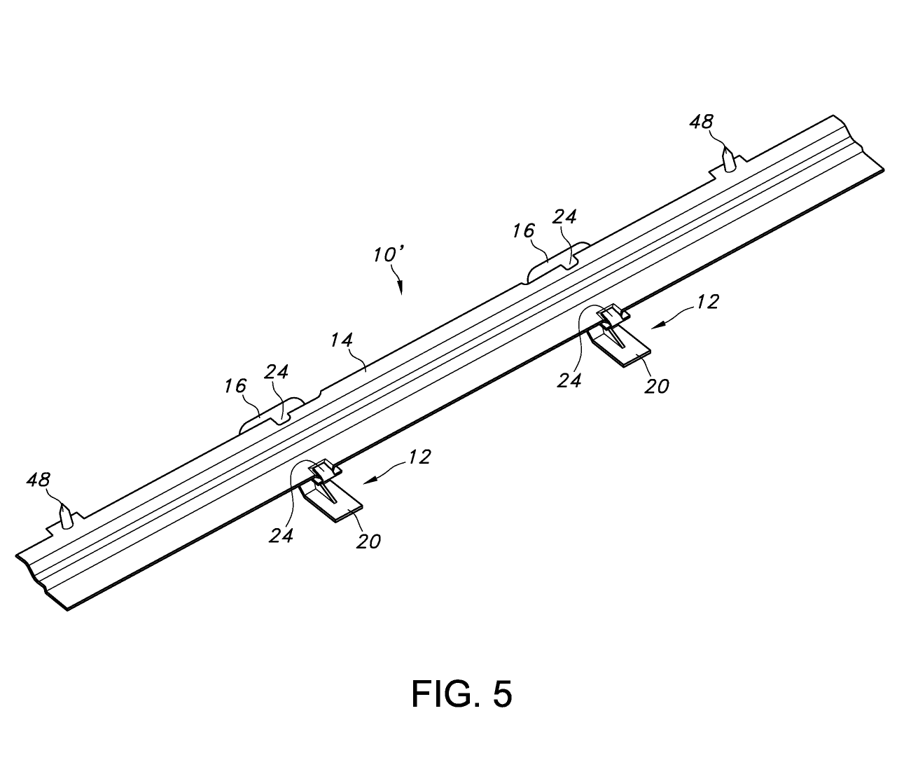

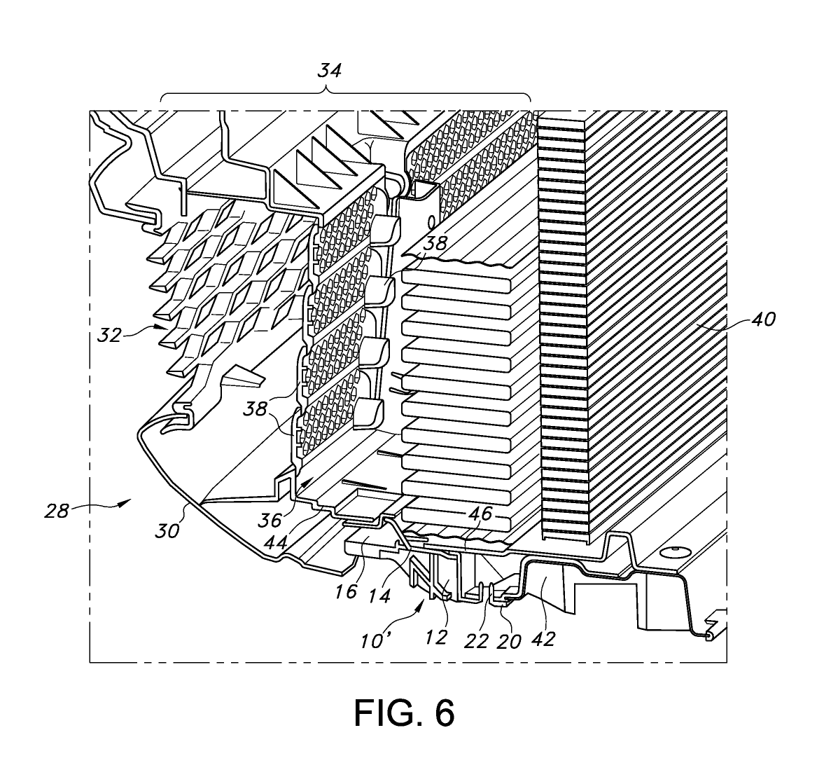

An alternative embodiment of the integrated NVH decoupler and front impact brace 10′ is shown in FIGS. 4 and 5. The depicted alternative embodiment, intended for lighter duty such as in smaller vehicles, may include alternative configurations and placements of bracket 12 as shown, and may also include optional additional self-threading screws for attaching air flow deflector strip 14 to grille shutter system housing 44. However, the basic form and function of the alternative integrated NVH decoupler and front impact brace 10, and it's placement on a vehicle (see FIG. 6), are substantially as described above.

By sealing the gap between the trailing edge of the grille shutter system housing 44 and the leading edge of the lower air deflector 46, the integrated NVH decoupler and front impact brace 10 substantially prevents air flow therethrough, managing air flow but also reducing noise that would otherwise be caused by unmanaged air flow. Moreover, because the air flow deflector strip 14 of the integrated NVH decoupler and front impact brace 10 is attached to braces 12 but otherwise decoupled from elements of the cooling system (i.e. the lower radiator support 42) or the grille shutter system (i.e. housing 44), vibration created by the cooling system and/or the grille shutter system is not transmitted by the air flow deflector strip 14 as would be the case for a conventional air flow deflector rigidly attached to the grille shutter system housing and/or the lower radiator support.

As a further advantage, brace 12 provides a rigid separator between the lower radiator support 42 and the grille shutter system housing 44. In the event of a frontal impact to the vehicle 28, the braces 12 preserve the spacing between the grille shutter system 36/grille shutter system housing 44 and elements of the cooling system such as the radiator 40. Thus, damage to elements of the cooling system is prevented, reducing repair costs, insurance liability and potentially insurance premiums paid customers, and the like.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. An integrated noise, vibration, and harshness (NVH) decoupler and front impact brace for a vehicle, comprising:
one or more brackets configured for attaching at a first end to a front grille support member and at an opposed end to a radiator support member; and
an air flow deflector strip associated with the one or more brackets, wherein the air flow deflector strip is configured to substantially prevent a flow of air through a gap defined between the front grille support member and a lower air deflector of the vehicle.

2. (canceled)

3. The integrated NVH decoupler and front impact brace of claim 1, wherein the air flow deflector strip is carried by the one or more brackets.

4. The integrated NVH decoupler and front impact brace of claim 1, wherein the front grille support member is a grille shutter system housing.

5. The integrated NVH decoupler and front impact brace of claim 1, wherein the radiator support member is a lower radiator support member.

6. The integrated NVH decoupler and front impact brace of claim 5, wherein the one or more brackets each include at least one snap-fit fastener for attaching to at least one cooperating aperture defined in the lower radiator support member.

7. The integrated NVH decoupler and front impact brace of claim 1, wherein the one or more brackets each include at least one reinforcing rib structure.

8. The integrated NVH decoupler and front impact brace of claim 3, wherein the one or more brackets each include at least one curved retainer for holding the air flow deflector strip.

9. A vehicle including the integrated NVH decoupler and front impact brace of claim 1.

10. An assembly for reducing noise, vibration, and harshness (NVH) in a vehicle, comprising:
a vehicle front grille support member;
a vehicle radiator support member; and
an integrated NVH decoupler and front impact brace including an air flow deflector strip carried by one or more brackets each configured for attaching at a first end to the front grille support member and at an opposed end to the radiator support member;
wherein the air flow deflector strip is configured to substantially prevent a flow of air through a gap defined between the front grille support member and a vehicle lower air deflector.

11. The assembly of claim 10, wherein the radiator support member is a lower radiator support.

12. The assembly of claim 10, wherein the front grille support member is a grille shutter system housing.

13. The assembly of claim 10, wherein the one or more brackets attach to the radiator support member by a snap-fit fastener.

14. The assembly of claim 10, wherein the one or more brackets each include at least one reinforcing rib structure.

15. The assembly of claim 10, wherein the one or more brackets each include at least one retainer for holding the air flow deflector strip.

16. The assembly of claim 10, wherein the one or more brackets each include a pair of retainers for holding the air flow deflector strip.

17. A vehicle including the assembly of claim 10.
